(19) United States
(12) Patent Application Publication
(10) Pub. No.: US 2023/0399778 A1
(43) Pub. Date: Dec. 14, 2023

(54) HEAT INSULATING, HEAT STORING, AND HEAT GENERATING MATERIAL AND METHOD FOR PRODUCING HEAT INSULATING, HEAT STORING, AND HEAT GENERATING MATERIAL

(71) Applicant: SEIKO EPSON CORPORATION, Tokyo (JP)

(72) Inventors: Satomi YOSHIOKA, Shiojiri (JP); Satoru YANAGI, Tokyo (JP); Kazuhiro ICHIKAWA, Okaya (JP); Satoru HOSONO, Azumino (JP); Jiro KATO, Suwa (JP); Tatsushi KATO, Chino (JP); Shunichi SEKI, Suwa (JP)

(21) Appl. No.: 18/331,213

(22) Filed: Jun. 8, 2023

(30) Foreign Application Priority Data
Jun. 10, 2022 (JP) 2022-094194

(51) Int. Cl. D04H 1/4382; F16L 59/02

(52) U.S. Cl. CPC D04H 1/43835; F16L 59/028

(57) ABSTRACT

A heat insulating, heat storing, and heat generating material includes first fibers having a function of generating heat through moisture absorption, second fibers having a diameter smaller than a diameter of the first fibers, and a binding material binding together the first fibers, binding together the second fibers, and binding together the first fibers and the second fibers. The binding material contains a thermoplastic resin.

The present application is based on, and claims priority from JP Application Serial Number 2022-094194, filed Jun. 10, 2022, the disclosure of which is hereby incorporated by reference herein in its entirety.

### BACKGROUND

### 1. Technical Field

The present disclosure relates a heat insulating, heat storing, and heat generating material and a method for producing a heat insulating, heat storing, and heat generating material.

### 2. Related Art

As disclosed in JP-A-2018-111913, mixed padding in which two or more types of fibers are mixed together is known in the related art. The two or more types of fibers include main fibers and functional fibers. The mixing ratio of the main fibers to the functional fibers is 50% by mass or more and 95% by mass or less to 5% by mass or more and 50% by mass or less. The specific gravity of the functional fibers is in a range of ±10% with respect to the specific gravity of the main fibers. Variations in the mixing ratio of the two or more types of fibers determined by the following equation are 10% by mass or less: maximum mixing ratio value−minimum mixing ratio value.

In recent years, recycling of resources to create new fiber materials, clothing products, and the like by using discarded clothing has been desired.

### SUMMARY

According to an aspect of the present disclosure, there is provided a heat insulating, heat storing, and heat generating material having two or more types of functional fibers including first fibers having a function of generating heat through moisture absorption and second fibers having a diameter smaller than a diameter of the first fibers and having functions of insulating heat and storing heat.

According to another aspect of the present disclosure, there is provided a heat insulating, heat storing, and heat generating material having first fibers having a function of generating heat through moisture absorption, second fibers having a diameter smaller than a diameter of the first fibers and having functions of insulating heat and storing heat, and a binding material binding together the first fibers, binding together the second fibers, and binding together the first fibers and the second fibers. The binding material contains a thermoplastic resin.

According to another aspect of the present disclosure, there is provided a method for producing a heat insulating, heat storing, and heat generating material. The method includes a mixing step of mixing together first fibers having a function of generating heat through moisture absorption and second fibers having a diameter smaller than a diameter of the first fibers and having functions of insulating heat and storing heat to generate a mixture; and a depositing step of depositing the mixture to form a web.

According to another aspect of the present disclosure, there is provided a method for producing a heat insulating, heat storing, and heat generating material. The method includes a mixing step of mixing together first fibers having a function of generating heat through moisture absorption, second fibers having a diameter smaller than a diameter of the first fibers and having functions of insulating heat and storing heat, and a binding material for binding together the first fibers, binding together the second fibers, and binding together the first fibers and the second fibers to generate a mixture; a depositing step of depositing the mixture to form a web; and a binding step of binding together the first fibers forming the web, binding together the second fibers forming the web, and binding together the first fibers and the second fibers forming the web to form a heat insulating, heat storing, and heat generating material.

### BRIEF DESCRIPTION OF THE DRAWINGS

FIG. 1 is a schematic diagram illustrating a configuration of an apparatus for producing a heat insulating, heat storing, and heat generating material.

FIG. 2 is an enlarged view of a heat insulating, heat storing, and heat generating material.

FIG. 3 is an enlarged view of the heat insulating, heat storing, and heat generating material.

FIG. 4 is a flowchart illustrating a method for producing the heat insulating, heat storing, and heat generating material.

FIG. 5 is a flowchart illustrating a method for producing another heat insulating, heat storing, and heat generating material.

### DESCRIPTION OF EXEMPLARY EMBODIMENTS

First, a configuration of an apparatus 1 for producing a heat insulating, heat storing, and heat generating material will be described. The apparatus 1 for producing a heat insulating, heat storing, and heat generating material is an apparatus for producing a heat insulating, heat storing, and heat generating material S.

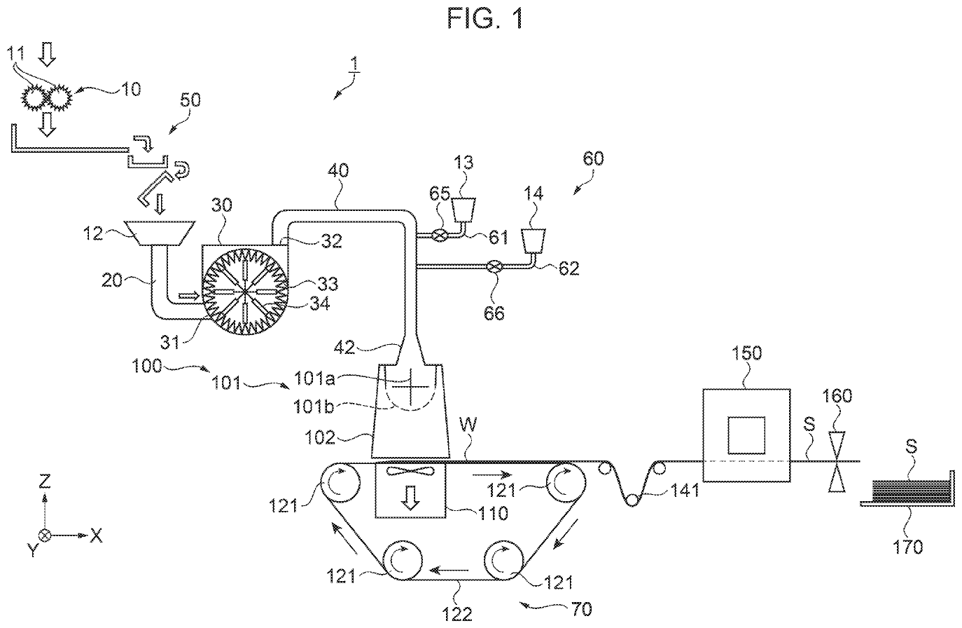

In FIG. 1, X-, Y-, and Z-axes, which are coordinate axes orthogonal to each other, are set. The direction indicated by an arrow is referred to as “+ direction”, and the direction opposite to the + direction is referred to as “− direction”. The +Z direction is the upward direction, whereas the −Z direction is the downward direction.

In the apparatus 1 for producing a heat insulating, heat storing, and heat generating material, a web W, and the like, the direction of the Y-axis is a width direction, whereas the direction of the Z-axis is a thickness direction. In the apparatus 1 for producing a heat insulating, heat storing, and heat generating material, the forward transport direction of a raw material, the web W, and the like is the downstream direction, and the direction opposite to the transport direction is the upstream direction.

As illustrated in FIG. 1, the apparatus 1 for producing a heat insulating, heat storing, and heat generating material includes, from upstream to downstream, a rough-crushing section 10, a defibrating section 30, a mixing section 60, a forming section 100, a web transporting section 70, a heating section 150, and a cutting section 160. The apparatus 1 for producing a heat insulating, heat storing, and heat generating material also includes a controller (processor) that comprehensively controls the operation of the above sections. The apparatus 1 for producing a heat insulating, heat storing, and heat generating material produces, for example, a sheet-shaped heat insulating, heat storing, and heat generating material S.

The rough-crushing section 10 roughly crushes a supplied raw material. Supply of the raw material to the rough-crushing section 10 is performed, for example, by an automatic feeding mechanism.

The raw material is a material containing fibers. Examples of the raw material that can be applied include clothing and old clothing that can be discarded, fabric, fabric waste, threads, lint, single fibers, filament fibers, staple fibers, fabric products, and various used fabric products.

The raw material contains first fibers F1 having a function of generating heat through moisture absorption and second fibers F2 having a diameter smaller than a diameter of the first fibers F1 and having functions of insulating heat and storing heat.

The material of the first fibers F1 is functional fibers having hydrophilic surfaces. Examples of the first fibers F1 include rayon, cupro, Lyocell, cotton, hemp, wool, cashmere, silk, polyvinyl alcohol (PVA), and down and feathers. The first fibers F1 easily adsorb water vapor on the fiber surfaces to facilitate water condensation on the fiber surfaces, thus effectively generating heat through moisture absorption. This results in good heat generating properties.

Examples of the material of the second fibers F2 include acrylic, polyester, nylon, polyester/nylon, polyethylene, and polypropylene. The ratio of the diameter of the second fibers F2 to the diameter of the first fibers F1 is in a range of 0.05 or more and 0.8 or less. That is, the diameter of the second fibers F2 is 5% or more and 80% or less of the diameter of the first fibers F1. The small diameter of the second fibers F2 results in narrow gaps between the first fibers F1 and the second fibers F2, thus reducing the flowability of air within the heat insulating, heat storing, and heat generating material S and improving heat retaining properties.

The raw material may contain other fibers in addition to the first fibers F1 and the second fibers F2. For example, fibers having a function such as an antibacterial, deodorizing, heat storing, antistatic, moisture absorbing, or strength-improving function may be contained.

Examples of fibers having an antistatic function include fibers made of hydrophilic resins. Examples of the fibers having an antistatic function include polyvinyl alcohol fibers and sodium polyacrylate fibers. The other fibers may be bound together by the first fibers F1, the second fibers F2, and the binding material R.

The rough-crushing section 10 shreds the supplied raw material in a gas such as air. The rough-crushing section 10 has rough-crushing blades 11. The rough-crushing section 10 is, for example, a shredder, a cutter mill, or a tow cutter. The raw material is shredded into small pieces by the rough-crushing blades 11. For example, the small pieces in plan view are a few millimeters square, are irregular in shape, or are staple fiber tows. The small pieces are collected into a fixed-amount supply section 50.

The fixed-amount supply section 50 weighs the small pieces and supplies them in fixed amounts to a hopper 12. The fixed-amount supply section 50 is, for example, a vibration feeder. The small pieces supplied to the hopper 12 are transported to an inlet port 31 of the defibrating section 30 via a pipe 20.

The defibrating section 30 includes the inlet port 31, a discharge port 32, a stator 33, a rotor 34, and an air flow generating mechanism (not shown). The defibrating section 30 defibrates the small pieces of the raw material by a dry process to generate a defibrated product. The small pieces of the raw material are introduced into the defibrating section 30 via the inlet port 31 by an air flow generated by the air flow generating mechanism. In the present specification, “dry process” refers to a process that is not performed in a liquid but is performed in a gas such as air.

The stator 33 and the rotor 34 are disposed inside the defibrating section 30. The stator 33 has a substantially cylindrical inner surface. The rotor 34 rotates along the inner surface of the stator 33. The small pieces of the raw material are held between the stator 33 and the rotor 34 and are defibrated by a shear force occurring therebetween.

The first fibers F1 and the second fibers F2 contained in the defibrated product may have a length of 1 mm or more and 100 mm or less. In this case, the fiber length is not extremely short, thus improving the mechanical strength of the heat insulating, heat storing, and heat generating material S. The fiber length is determined by a method pursuant to ISO 16065-2:2007.

In the defibrated product, the number of fibers (staple fibers) with a fiber length shorter than the average fiber length (e.g., 4.8 mm) is 1% or more and 95% or less of the total number of the first fibers F1 and the second fibers F2. The staple fibers serve as bridging structures between filament fibers, which are longer than the average fiber length, to form fine air layers. This improves heat retaining properties.

The defibrating processing by the defibrating section 30 bends the first fibers F1 and the second fibers F2. By bending, the volume of the first fibers F1 and the second fibers F2 is increased, thus improving heat retaining properties. In particular, by performing the defibrating processing on a raw material containing twisted fibers, a defibrated product containing first fibers F1 and second fibers F2 that are more bent can be obtained.

The defibrated product is discharged from the discharge port 32 of the defibrating section 30 into a pipe 40. The pipe 40 communicates with the inside of the defibrating section 30 and the inside of the forming section 100. The defibrated product is transported from the defibrating section 30 to the forming section 100 via the pipe 40 by the air flow generated by the air flow generating mechanism. The pipe 40 is provided with the mixing section 60.

The mixing section 60 includes hoppers 13 and 14, supply pipes 61 and 62, and valves 65 and 66. The mixing section 60 mixes the binding material R and additives into the defibrated product transported through the air in the pipe 40. By this mixing, a mixture is generated.

The hopper 13 supplies the binding material R into the pipe 40. The hopper 13 communicates with the inside of the pipe 40 via the supply pipe 61. In the supply pipe 61, the valve 65 is disposed between the hopper 13 and the pipe 40. The valve 65 adjusts the weight of the binding material R to be supplied to the pipe 40 from the hopper 13. The valve 65 adjusts the mixing ratio of the binding material R to the defibrated product.

The binding material R binds together the first fibers F1, binds together the second fibers F2, and binds together the first fibers F1 and the second fibers F2. The binding material R contains a thermoplastic resin. The thermoplastic resin is one or more of powder resins, fiber resins, and core-sheath resins, and the melting temperature thereof is 100° C. or higher and 180° C. or lower.

For the binding material R, one or more of a thermoplastic resin (polyolefin (PE or PP), polyester, nylon, polylactic acid, or the like), heat-fusible fibers (polyester, polyolefin (PE or PP), polyolefin/polyester, nylon, polylactic acid, or the like), and heat-shrinkable fibers (polyester, polylactic acid, or the like) are used. For example, by binding the first fibers F1 and the second fibers F2 together using heat-shrinkable fibers, inter-fiber gaps can be maintained while preventing the first fibers F1 and the second fibers F2 from diffusing, and it is possible to virtually form a down nucleus structure like a down ball.

For the binding material R, core-sheath resins having a core-sheath structure may be used. Specifically, the binding material R has a core-sheath structure formed by a core Ra formed of polyester and a covering layer Rb of a thermoplastic resin (e.g., polyolefin) covering the core Ra. In this case, the polyolefin forming the covering layer Rb is melted by heating treatment, thereby bonding, for example, the first fibers F1 and the second fibers F2 together with the polyester interposed therebetween. The fibers are bonded together with the core Ra of polyester interposed therebetween, and thus tensile strength can be improved.

The hopper 13 may supply multifilaments of staple fibers obtained by cutting rayon (first fibers F1) and acrylic (second fibers F2) in advance into the pipe 40 in place of the binding material R. The hopper 13 communicates with the inside of the pipe 40 via the supply pipe 61. In the supply pipe 61, the valve 65 is disposed between the hopper 13 and the pipe 40. The valve 65 adjusts the weight of the first fibers F1 and the second fibers F2 to be supplied to the pipe 40 from the hopper 13.

The hopper 14 supplies the additives into the pipe 40. The hopper 14 communicates with the inside of the pipe 40 via the supply pipe 62. In the supply pipe 62, the valve 66 is disposed between the hopper 14 and the pipe 40. The valve 66 adjusts the weight of the additives to be supplied to the pipe 40 from the hopper 14. The valve 66 adjusts the mixing ratio of the additives to the defibrated product and the binding material R.

Examples of the additives include colorants, fire retardants, antioxidants, UV absorbers, flocculation inhibitors, antibacterial agents, mold inhibitors, waxes, and release agents. The additives may be powdery or fibrous.

The additives may be mixed with the binding material R in advance and then be supplied from the hopper 13.

The hopper 14 may supply an additive material such as down or feathers into the pipe 40 in place of the additives. The hopper 14 communicates with the inside of the pipe 40 via the supply pipe 62. In the supply pipe 62, the valve 66 is disposed between the hopper 14 and the pipe 40. The valve 66 adjusts the weight of the additive material to be supplied to the pipe 40 from the hopper 14. The valve 66 adjusts the mixing ratio of the additive material to the defibrated product or to the defibrated product and the binding material R.

The defibrated product or the defibrated product and the binding material R and the like are mixed together to form a mixture while being transported through the pipe 40 to the forming section 100. To facilitate generation of the mixture and improve the transportability of the mixture in the pipe 40, a blower or the like that generates an air flow may be disposed in the pipe 40. The mixture is introduced to the forming section 100 via a supply member 42 coupling the downstream end of the pipe 40 to the forming section 100.

The forming section 100 deposits the mixture in air to form the web W. The forming section 100 has a dispersing section 101 and a depositing section 102. The dispersing section 101 is disposed inside the depositing section 102. The inside of the dispersing section 101 communicates with the pipe 40 via the supply member 42. The web transporting section 70 is disposed below the depositing section 102.

The dispersing section 101 includes a rotary member 101a and a drum 101b housing the rotary member 101a. The forming section 100 sends the mixture from the supply member 42 into the dispersing section 101 and deposits it onto a mesh belt 122 of the web transporting section 70 by a dry process.

The inside of the supply member 42 communicates with the inside of the drum 101b. The drum 101b is a substantially columnar member and is disposed in the Y-axis direction. The lower portion of the drum 101b is formed of a metallic mesh. The holes of the metallic mesh allow the first fibers F1, the second fibers F2, the binding material R, and the like contained in the mixture to pass therethrough.

The rotary member 101a includes a plurality of blades including a plurality of openings. The rotary member 101a rotates about an axis of rotation in the Y-axis direction in response to the drive of a drive section while being supported by a support.

The depositing section 102 is a substantially box-shaped member. The supply member 42 is disposed above the upper surface of the depositing section 102, and the dispersing section 101 is disposed inside the upper surface of the depositing section 102. The area corresponding to the bottom surface of the depositing section 102 is open downward. The dispersing section 101 is disposed inside the depositing section 102 and faces the upper surface of the mesh belt 122 of the web transporting section 70. The depositing section 102 is formed of, for example, resin or metal.

The mixture is introduced into the supply member 42 to be led to the inside of the dispersing section 101 via the supply member 42. The mixture passes through the openings of the rotating rotary member 101a and between the rotary member 101a and the drum 101b while being disentangled. The first fibers F1, the second fibers F2, and the like in the mixture in an entangled state are disentangled and separated into individual fibers and pass through the mesh of the drum 101b. Thus, the dispersing section 101 disperses the first fibers F1, the second fibers F2, the binding material R, and the like contained in the mixture in the air inside the depositing section 102.

The mixture is discharged from the inside of the dispersing section 101 into the air inside the depositing section 102 and is guided above the mesh belt 122 by gravity and the suction force of a suction mechanism 110. That is, the depositing section 102 deposits the mixture containing the first fibers F1, the second fibers F2, and the binding material R, which are dispersed, to form the web W.

The web transporting section 70 includes the mesh belt 122 and the suction mechanism 110. The mesh belt 122 is an endless belt and is placed around four tension rollers 121.

The mesh belt 122 does not hinder the suction by the suction mechanism 110 and has sufficient strength to hold the web W or the like. The mesh belt 122 is formed of, for example, metal or resin. The hole diameter of the mesh of the mesh belt 122, which is not particularly limited, may be 60 μm or more and 125 μm or less.

At least one of the four tension rollers 121 is rotationally driven by a motor (not shown). The upper surface of the mesh belt 122 is moved downstream by the rotation of the tension rollers 121. In other words, the mesh belt 122 rotates clockwise in FIG. 1. By the rotation of the mesh belt 122, the web W is transported downstream.

The suction mechanism 110 is disposed below the dispersing section 101. The suction mechanism 110 facilitates deposition of the mixture onto the mesh belt 122. The suction mechanism 110 sucks air within the depositing section 102 via the holes of the mesh belt 122. The holes of the mesh belts 122 allow air to pass therethrough but make it difficult for the first fibers F1, the second fibers F2, the binding material R, and the like contained in the mixture to pass therethrough. The mixture discharged from the dispersing section 101 to the inside of the depositing section 102 is sucked downward together with air. For the suction mechanism 110, a known sucking device, such as a blower, is employed.

With this configuration, the mixture within the depositing section 102 is deposited onto the mesh belt 122 by the suction force of the suction mechanism 110 in addition to gravity to form the web W. The web W contains a relatively large amount of air, which causes gentle swelling. The web W is transported downstream by the mesh belt 122.

A humidifier may be disposed downstream of the depositing section 102 to spray mist and humidify the web W on the mesh belt 122. This reduces scattering of the first fibers F1, the second fibers F2, the binding material R, and the like contained in the web W. In addition, a water-soluble additive or the like may be contained in the water for use in humidification to impregnate the web W with the additive concurrently with humidification.

A dancer roller 141 is disposed downstream of the web transporting section 70. The web W, after being peeled from the most downstream tension roller 121, is pulled to the dancer roller 141. The dancer roller 141 ensures a downstream processing time. Specifically, heating treatment at the heating section 150 is batch processing. Thus, the dancer roller 141 is moved up and down to delay the time at which the web W continuously transported from the depositing section 102 reaches the heating section 150.

The heating section 150 melts the thermoplastic resin contained in the binding material R to bind together the first fibers F1, bind together the second fibers F2, and bind together the first fibers F1 and the second fibers F2 to form the heat insulating, heat storing, and heat generating material S. The heating section 150 is, for example, an oven. The web W is heated by infrared radiation produced by the oven. This melts the binding material R contained in the web W. The heating temperature is 100° C. or higher and 180° C. or lower and more preferably 100° C. or higher and 150° C. or lower. When the binding material R of a core-sheath structure is used, the heating temperature may be a temperature that melts the covering layer Rb but that does not melt the core Ra. The heating temperature is determined as appropriate in accordance with the properties of the heat insulating, heat storing, and heat generating material S to be formed.

With the first fibers F1, the second fibers F2, and the binding material R in the web W being randomly oriented, the first fibers F1 are partially bonded together, the second fibers F2 are partially bonded together, the pieces of the binding material R are partially bonded together, and the first fibers F1 and the second fibers F2 are partially bonded together. The heat insulating, heat storing, and heat generating material S is a formed body containing the first fibers F1, the second fibers F2, and the binding material R.

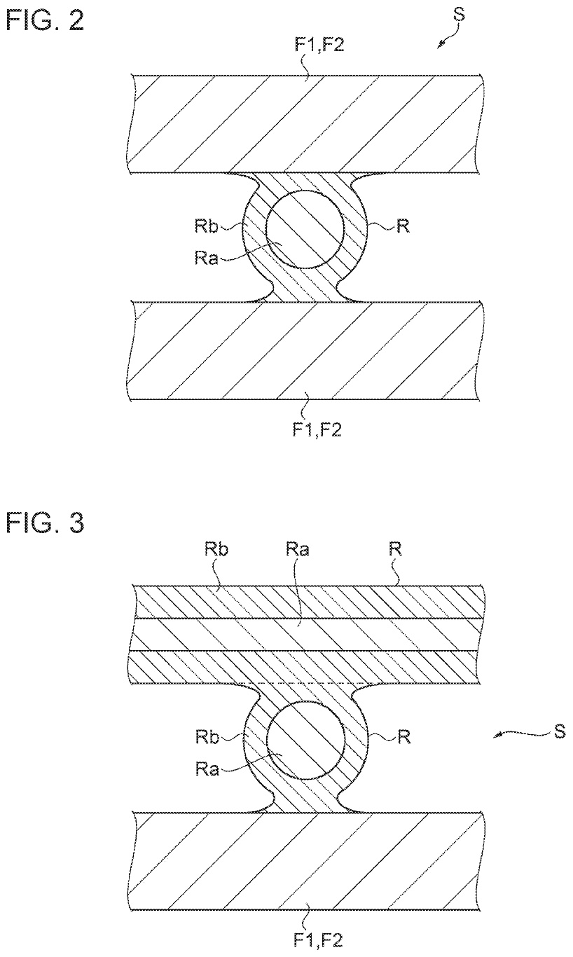

When the binding material R of a core-sheath structure is used, flexibility and strength can be increased regardless of directionality since the core Ra of the binding material R has a function of increasing rigidity. More specifically, as illustrated in FIG. 2, for example, in portions in which first fibers F1 (second fibers F2) and the binding material R are in contact with each other, the covering layer Rb of the binding material R is melted by heat. Then, the melted portion of the covering layer Rb spreads to the outer surfaces of the first fibers F1 (second fibers F2) and is cured in that state, thereby bonding the first fibers F1 (second fibers F2) and the second fibers F2 (first fibers F1) together.

As illustrated in FIG. 3, in a portion in which pieces of the binding material R are in contact with each other, the respective covering layers Rb are melted by heat, are spread to each other's surface, and are cured in that state, thereby bonding the pieces of the binding material R together.

Thus, the first fibers F1, the second fibers F2, and the binding material R are partially bonded together through heat fusion while being randomly oriented. Therefore, the heat insulating, heat storing, and heat generating material S as a whole is readily deformable in response to external pressure while having sufficient strength.

In addition, the core Ra of the binding material R remains after heating, thereby leaving the binding material R with so-called resilience. Consequently, sufficient strength of the heat insulating, heat storing, and heat generating material S as a whole can be ensured. In addition, the fine gaps formed within the heat insulating, heat storing, and heat generating material S can be ensured.

The formed sheet-shaped heat insulating, heat storing, and heat generating material S is transported to the downstream cutting section 160.

The cutting section 160 cuts the sheet-shaped heat insulating, heat storing, and heat generating material S into a strip shape. The cutting section 160 includes a longitudinal blade and a lateral blade. The longitudinal blade and the lateral blade are, for example, rotary cutters. In place of the rotary cutters, ultrasonic cutters or the like may be used.

The longitudinal blade cuts the sheet-shaped heat insulating, heat storing, and heat generating material S in a direction parallel to the transport direction. The lateral blade cuts the sheet-shaped heat insulating, heat storing, and heat generating material S in a direction crossing the transport direction. Thus, a strip-shaped heat insulating, heat storing, and heat generating material S is formed. That is, the heat insulating, heat storing, and heat generating material S containing the first fibers F1, the second fibers F2, the other functional fibers, and the binding material R is formed. The strip-shaped heat insulating, heat storing, and heat generating material S is housed in a tray 170.

The shape of the heat insulating, heat storing, and heat generating material S is not limited to a sheet shape but may be, for example, a fiber ball shape or a nucleated shape having a nucleus.

The thus-formed heat insulating, heat storing, and heat generating material S can be used as, for example, padding for clothing.

Next, a method for producing the heat insulating, heat storing, and heat generating material S will be described.

In the present embodiment, a method for producing the heat insulating, heat storing, and heat generating material S by using the apparatus 1 for producing a heat insulating, heat storing, and heat generating material will be described.

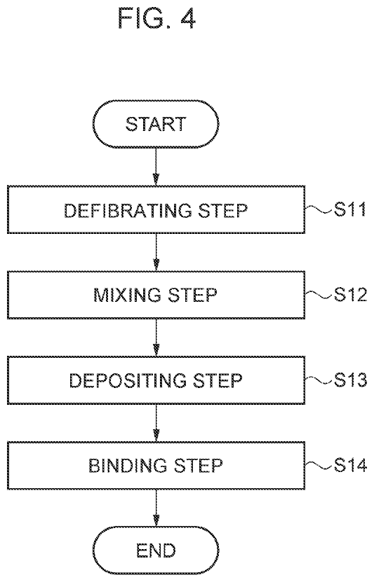

As illustrated in FIG. 4, in a defibrating step (Step S11), old cloth is defibrated to generate a defibrated product containing the first fibers F1 and the second fibers F2.

Specifically, defibrating processing is performed using the defibrating section 30 to generate the defibrated product. The first fibers F1 and the second fibers F2 defibrated in the defibrating step have a length of 1 mm or more and 100 mm or less.

Before the defibrating processing, rough-crushing processing to roughly crush the old cloth into small pieces may be performed. The small pieces obtained by this processing can be efficiently defibrated to generate the defibrated product.

In addition, a plurality of types of old clothing may be mixed together and may be subjected to the rough-crushing processing and the defibrating processing.

Next, in a mixing step (Step S12), the first fibers F1 having a function of generating heat through moisture absorption, the second fibers F2 having a diameter smaller than a diameter of the first fibers F1 and having functions of insulating heat and storing heat, and the binding material R for binding together the first fibers F1, binding together the second fibers F2, and binding together the first fibers F1 and the second fibers F2 are mixed together to generate a mixture.

Specifically, the mixture is generated by supplying the binding material R to the defibrated product from the mixing section 60. The binding material R contains a thermoplastic resin.

Next, in a depositing step (Step S13), the mixture is deposited to form the web W.

Specifically, the dispersing section 101 disperses, in air, the first fibers F1, the second fibers F2, and the binding material R contained in the mixture, and the depositing section 102 deposits the dispersed mixture to form the web W.

Next, in a binding step (Step S14), the heat insulating, heat storing, and heat generating material S is formed by binding together the first fibers F1 forming the web W, binding together the second fibers F2 forming the web W, and binding together the first fibers F1 and the second fibers F2 forming the web W.

Specifically, heating treatment is performed using the heating section 150. This melts the binding material R to bind the fibers together (FIG. 2 and FIG. 3). The heating temperature is 100° C. or higher and 180° C. or lower and more preferably 100° C. or higher and 150° C. or lower.

Thus, the heat insulating, heat storing, and heat generating material S containing the first fibers F1, the second fibers F2, and the binding material R is formed.

Next, a method for producing another heat insulating, heat storing, and heat generating material S will be described.

In the present embodiment, a method for producing the other heat insulating, heat storing, and heat generating material S by using the apparatus 1 for producing a heat insulating, heat storing, and heat generating material will be described.

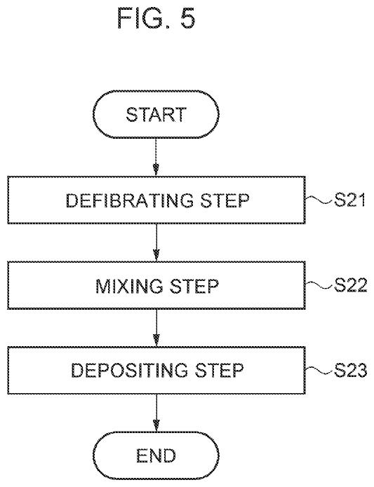

As illustrated in FIG. 5, in a defibrating step (Step S21), staple fibers are defibrated to generate a defibrated product containing the first fibers F1 and the second fibers F2.

Specifically, defibrating processing is performed using the defibrating section 30 to generate the defibrated product. The first fibers F1 and the second fibers F2 defibrated in the defibrating step have a length of 1 mm or more and 100 mm or less.

Before the defibrating processing, rough-crushing processing to roughly crush filament fibers into small pieces may be performed. The small pieces obtained by this processing can be efficiently defibrated to generate the defibrated product.

A plurality of types of fibers may be mixed together and may be subjected to the rough-crushing processing and the defibrating processing.

Next, in a mixing step (Step S22), the first fibers F1 having a function of generating heat through moisture absorption and the second fibers F2 having a diameter smaller than a diameter of the first fibers F1 and having functions of insulating heat and storing heat are mixed together to generate a mixture.

Next, in a depositing step (Step S23), the mixture is deposited to form the web W.

Specifically, the dispersing section 101 disperses, in air, the first fibers F1, the second fibers F2, and the like contained in the mixture, and the depositing section 102 deposits the dispersed mixture to form the other heat insulating, heat storing, and heat generating material S.

Thus, the other heat insulating, heat storing, and heat generating material S containing the first fibers F1 and the second fibers F2 is formed. That is, the other heat insulating, heat storing, and heat generating material S does not contain any binding material.

A surfactant may be added to the heat insulating, heat storing, and heat generating material S and the other heat insulating, heat storing, and heat generating material S. For example, a surfactant such as a cationic surfactant or a nonionic surfactant is sprayed onto the heat insulating, heat storing, and heat generating material S (other heat insulating, heat storing, and heat generating material S) with a spray. This can improve an antistatic effect.

Thus, according to the present embodiment, the heat insulating, heat storing, and heat generating material S and the other heat insulating, heat storing, and heat generating material S having excellent heat insulating properties, heat storing properties (heat retaining properties), and heat generating properties can be formed by using, for example, functional fibers that are filament fibers and/or staple fibers. This can expand the range of applications of functional fibers.

Next, examples will be described.

### Example 1

Clothing made of a mixed fabric of rayon (first fibers F1), acrylic (second fibers F2), polyester (other fibers), and the like was roughly crushed with a cutter mill (manufactured by Makino Mfg. Co. Ltd.), which served as pretreatment for fiberization by defibration. The roughly crushed product had a long side with a length of 5 mm.

Next, the roughly crushed small pieces were defibrated and fiberized by the defibrating section 30.

Next, a binding material R of a core-sheath structure (the core Ra was made of polyester and the covering layer Rb was made of polyolefin) in an amount of 20% by weight was added to the fibers in an amount of 80% by weight, and these were mixed together by air stirring.

Next, a web W with a weight per unit area of 80 g/m² was formed.

Next, the web W was heated by the heating section 150. The heating conditions included 135° C. and 5 minutes. Then, a sheet-shaped heat insulating, heat storing, and heat generating material S with a thickness of 10 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 4.8 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the heat insulating, heat storing, and heat generating material S is highly effective in terms of heat insulating properties, heat storing properties (heat retaining properties), and heat generating properties.

### Example 2

Clothing made of a mixed fabric of rayon (first fibers F1), acrylic (second fibers F2), polyester (other fibers), and the like was roughly crushed with a cutter mill (manufactured by Makino Mfg. Co. Ltd.), which served as pretreatment for fiberization by defibration. The roughly crushed product had a long side with a length of 5 mm.

Next, the roughly crushed small pieces were defibrated and fiberized by the defibrating section 30.

Next, a binding material R of a core-sheath structure (the core Ra and the covering layer Rb were made of polylactic acid, where Ra>Rb in melting point) in an amount of 15% by weight was added to the fibers in an amount of 85% by weight, and these were mixed together by air stirring.

Next, a web W with a weight per unit area of 100 g/m² was formed.

Next, the web W was heated by the heating section 150. The heating conditions included 125° C. and 10 minutes. Then, a sheet-shaped heat insulating, heat storing, and heat generating material S with a thickness of 12 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 4.8 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the heat insulating, heat storing, and heat generating material S is highly effective in terms of heat insulating properties, heat storing properties (heat retaining properties), and heat generating properties.

### Example 3

Clothing made of a mixed fabric of rayon (first fibers F1), acrylic (second fibers F2), polyester (other fibers), and the like and a polypropylene unwoven fabric were roughly crushed with a cutter mill (manufactured by Makino Mfg. Co. Ltd.), which served as pretreatment for fiberization by defibration. The roughly crushed product had a long side with a length of 5 mm.

Next, the roughly crushed small pieces were defibrated and fiberized by the defibrating section 30.

Next, a binding material R of a core-sheath structure (the core Ra was made of polyester and the covering layer Rb was made of polyolefin) in an amount of 10% by weight was added to the fibers in an amount of 90% by weight, and these were mixed together by air stirring.

Next, a web W with a weight per unit area of 80 g/m² was formed.

Next, the web W was heated by the heating section 150. The heating conditions included 130° C. and 1 minute. Then, a sheet-shaped heat insulating, heat storing, and heat generating material S with a thickness of 6 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 4.9 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the heat insulating, heat storing, and heat generating material S is highly effective in terms of heat insulating properties, heat storing properties (heat retaining properties), and heat generating properties.

### Example 4

Clothing made of a mixed fabric of rayon (first fibers F1), acrylic (second fibers F2), polyester (other fibers), and the like was roughly crushed with a cutter mill (manufactured by Makino Mfg. Co. Ltd.), which served as pretreatment for fiberization by defibration. The roughly crushed product had a long side with a length of 5 mm.

Next, the roughly crushed small pieces were defibrated and fiberized by the defibrating section 30.

Next, a binding material R of a core-sheath structure (the core Ra and the covering layer Rb were made of polylactic acid, where Ra>Rb in melting point) in an amount of 15% by weight and down, feathers, or the like in an amount of 10% by weight were added to the fibers in an amount of 75% by weight, and these were mixed together by air stirring.

Next, a web W with a weight per unit area of 100 g/m² was formed.

Next, the web W was heated by the heating section 150. The heating conditions included 125° C. and 10 minutes. Then, a sheet-shaped heat insulating, heat storing, and heat generating material S with a thickness of 12 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 4.8 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the heat insulating, heat storing, and heat generating material S is highly effective in terms of heat insulating properties, heat storing properties (heat retaining properties), and heat generating properties.

### Example 5

Clothing made of a mixed fabric of rayon (first fibers F1), acrylic (second fibers F2), polyester (other fibers), and the like and clothing containing padding of polyester and the like were roughly crushed with a cutter mill (manufactured by Makino Mfg. Co. Ltd.), which served as pretreatment for fiberization by defibration. The roughly crushed product had a long side with a length of 5 mm.

Next, the roughly crushed small pieces were defibrated and fiberized by the defibrating section 30.

Next, a binding material R of a core-sheath structure (the core Ra was made of polyester and the covering layer Rb was made of polyolefin) in an amount of 20% by weight was added to the fibers in an amount of 80% by weight, and these were mixed together by air stirring.

Next, a web W with a weight per unit area of 150 g/m² was formed.

Next, the web W was heated by the heating section 150. The heating conditions included 150° C. and 5 minutes. Then, a sheet-shaped heat insulating, heat storing, and heat generating material S with a thickness of 15 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 4.8 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the heat insulating, heat storing, and heat generating material S is highly effective in terms of heat insulating properties, heat storing properties (heat retaining properties), and heat generating properties.

### Example 6

Tows of rayon (first fibers F1) filament fibers and tows of acrylic (second fibers F2) filament fibers were cut into a staple fiber shape with a tow cutter in advance to form multifilaments with a fiber length of staple fibers of 20 mm to 50 mm. The staple fibers of the first fibers F1 and the second fibers F2 were uniformly mixed together by mixing and blowing or with a mixer or the like, and a web W was formed. Thus, another sheet-shaped heat insulating, heat storing, and heat generating material S with a weight per unit area of 150 g/m² and a thickness of 12 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 35 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the other heat insulating, heat storing, and heat generating material S is highly effective in terms of heat insulating properties, heat storing properties (heat retaining properties), and heat generating properties.

### Example 7

Tows of rayon (first fibers F1) filament fibers and tows of acrylic (second fibers F2) filament fibers were cut into a staple fiber shape with a tow cutter in advance to form linear multifilaments with a fiber length of staple fibers of 20 mm to 50 mm. The first fibers F1 and the second fibers F2 were mixed together by air stirring. The staple fibers of the first fibers F1 and the second fibers F2 were disentangled into monofilaments by the defibrating section 30 while the linear fibers were bent and provided with bulkiness by the shear force of the defibrating section 30, and a web W was formed. Thus, another sheet-shaped heat insulating, heat storing, and heat generating material S with a weight per unit area of 150 g/m² and a thickness of 12 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 35 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the other heat insulating, heat storing, and heat generating material S is highly effective in terms of heat insulating properties, heat storing properties (heat retaining properties), and heat generating properties.

### Example 8

Tows of rayon (first fibers F1) filament fibers and tows of acrylic (second fibers F2) filament fibers were cut into a staple fiber shape with a tow cutter in advance to form linear multifilaments with a fiber length of staple fibers of 20 mm to 50 mm. The staple fibers of the first fibers F1 and the second fibers F2 were disentangled into monofilaments by the defibrating section 30 while the linear fibers were bent and provided with bulkiness by the shear force of the defibrating section 30. Next, down, feathers, or the like in an amount of 15% by weight was added to the fibers in an amount of 85% by weight, these were mixed together by air stirring, and a web W was formed. Thus, another sheet-shaped heat insulating, heat storing, and heat generating material S with a weight per unit area of 100 g/m² and a thickness of 10 mm was produced.

The fibers after fiberization (first fibers F1, second fibers F2, and other fibers) were observed and subjected to length measurement with a digital microscope (VHX-5000 manufactured by Keyence Corporation). The average fiber length (length-weighted average) was 35 mm. The fibers had an uneven fiber length distribution.

The above revealed that staple fibers shorter than the average fiber length served as bridging structures with filament fibers, facilitating formation of pores (gaps) of various sizes within the web W.

It is thus thought that the other heat insulating, heat storing, and heat generating material S is highly effective in terms of heat insulating properties, heat storing properties (heat retaining properties), and heat generating properties.

What is claimed is:

1. A heat insulating, heat storing, and heat generating material comprising:
first fibers having a function of generating heat through moisture absorption;
second fibers having a diameter smaller than a diameter of the first fibers and having functions of insulating heat and storing heat; and
a binding material binding together the first fibers, binding together the second fibers, and binding together the first fibers and the second fibers, wherein
the binding material contains a thermoplastic resin.

2. The heat insulating, heat storing, and heat generating material according to claim 1, wherein
a material of the first fibers is rayon.

3. The heat insulating, heat storing, and heat generating material according to claim 1, wherein
a material of the second fibers is acrylic.

4. The heat insulating, heat storing, and heat generating material according to claim 1, wherein
a ratio of the diameter of the second fibers to the diameter of the first fibers is in a range of 0.05 or more and 0.8 or less.

5. The heat insulating, heat storing, and heat generating material according to claim 1, wherein
the binding material has a core formed of polyester and a covering layer of the thermoplastic resin covering the core.

6. The heat insulating, heat storing, and heat generating material according to claim 1, wherein
a number of fibers with a fiber length shorter than an average fiber length is 1% or more and 95% or less of a total number of the first fibers and the second fibers.

7. The heat insulating, heat storing, and heat generating material according to claim 1, further comprising a surfactant.

8. A method for producing a heat insulating, heat storing, and heat generating material, comprising:
a mixing step of mixing together first fibers having a function of generating heat through moisture absorption, second fibers having a diameter smaller than a diameter of the first fibers and having functions of insulating heat and storing heat, and a binding material for binding together the first fibers, binding together the second fibers, and binding together the first fibers and the second fibers to generate a mixture;
a depositing step of depositing the mixture to form a web; and
a binding step of binding together the first fibers forming the web, binding together the second fibers forming the web, and binding together the first fibers and the second fibers forming the web to form a heat insulating, heat storing, and heat generating material.

9. The method for producing a heat insulating, heat storing, and heat generating material according to claim 8, further comprising, before the mixing step, a defibrating step of defibrating old cloth to generate a defibrated product containing the first fibers and the second fibers.

10. The method for producing a heat insulating, heat storing, and heat generating material according to claim 9, wherein
the first fibers and the second fibers defibrated in the defibrating step have a length of 1 mm or more and 100 mm or less.

11. The method for producing a heat insulating, heat storing, and heat generating material according to claim 8, wherein
the binding material contains a thermoplastic resin and
heating treatment is performed at a heating temperature of 100° C. or higher and 180° C. or lower in the binding step.

12. The method for producing a heat insulating, heat storing, and heat generating material according to claim 8, wherein
after the binding step, a surfactant is added to the heat insulating, heat storing, and heat generating material.

13. A heat insulating, heat storing, and heat generating material comprising:
first fibers having a function of generating heat through moisture absorption; and
second fibers having a diameter smaller than a diameter of the first fibers and having functions of insulating heat and storing heat.

14. The heat insulating, heat storing, and heat generating material according to claim 13, wherein
a material of the first fibers is rayon.

15. The heat insulating, heat storing, and heat generating material according to claim 13, wherein
a material of the second fibers is acrylic.

16. The heat insulating, heat storing, and heat generating material according to claim 13, wherein
a ratio of the diameter of the second fibers to the diameter of the first fibers is in a range of 0.05 or more and 0.8 or less.

17. The heat insulating, heat storing, and heat generating material according to claim 13, wherein
a number of fibers with a fiber length shorter than an average fiber length is 1% or more and 95% or less of a total number of the first fibers and the second fibers.

18. The heat insulating, heat storing, and heat generating material according to claim 13, further comprising a surfactant.

19. A method for producing a heat insulating, heat storing, and heat generating material, comprising:
a mixing step of mixing together first fibers having a function of generating heat through moisture absorption and second fibers having a diameter smaller than a diameter of the first fibers and having functions of insulating heat and storing heat to generate a mixture; and
a depositing step of depositing the mixture to form a web.

20. The method for producing a heat insulating, heat storing, and heat generating material according to claim 19, further comprising, before the mixing step, a defibrating step of defibrating functional fibers that are filament fibers and/or staple fibers to generate a defibrated product containing the first fibers and the second fibers.

21. The method for producing a heat insulating, heat storing, and heat generating material according to claim 20, wherein
the first fibers and the second fibers defibrated in the defibrating step have a length of 1 mm or more and 100 mm or less.
